(19) United States
(12) Patent Application Publication
(10) Pub. No.: US 2008/0036794 A1
(43) Pub. Date: Feb. 14, 2008

(54) System and method for personalized scrolling banner

(76) Inventors: Guy Weiser, Tel Aviv (IL); Gady Shlasky, Kochav Yair (IL)

Correspondence Address: PEARL COHEN ZEDEK LATZER, LLP, 1500 BROADWAY 12TH FLOOR, NEW YORK, NY, 10036, US

(21) Appl. No.: 11/882,783

(22) Filed: Aug. 6, 2007

Related U.S. Application Data
(60) Provisional application No. 60/836,973, filed on Aug. 11, 2006.

(51) Int. Cl. G09G 5/00

(52) U.S. Cl. 345/689

(57) ABSTRACT

A system and method of delivering pre-selected categories of message data from a server to a client, and displaying such message data in a designated area of a screen, where the designated area appears in a display of many applications that may be shown on such screen.

### CROSS REFERENCE TO RELATED APPLICATION

This application claims the benefit of prior U.S. Provisional Patent Application No. 60/836,973, filed on Aug. 11, 2006 and entitled ‘Device, System and Method for Delivering and Presenting Personalized Information’, incorporated herein by reference in its entirety.

### FIELD OF THE INVENTION

The present invention generally relates to displays of personalized information on a computer screen, and particularly to a banner that provides personalized information to a user's computer screen.

### BACKGROUND OF THE INVENTION

Currently, a user of a computer application may receive message data on a first application, such as an email application, and receive a notice of such receipt while his screen displays another application. Such notice may be a noise or a fade box that briefly displays an indication of the message or of the receipt of the message. Upon such indication, a user may click the fade box or enter the email application to read the message data. Many users find both the noise and the intrusion of the fade box to be an annoyance, and furthermore are distracted by the need to enter into a separate application to read the received message data.

### SUMMARY OF THE INVENTION

In some embodiments, a method may include designating an area on a computer screen as a display area for message data, where the display area appears whenever one or more of a group of programs is displayed on the computer screen, accepting the message data from a server, where the accepted message data corresponds to categories of message data that are pre-selected and displaying the accepted message data on the display area.

In some embodiments, displaying the message data on the display area may include scrolling the message date on the display area. In some embodiments, accepting may include accepting a unit of message data at a frequency that is pre-selelcted. In some embodiments, accepting may include accepting a signal from an operator of the screen to request additional data about the message data.

In some embodiments, accepting may include accepting a signal from the user of the screen to suspend a unit of message data in the designated display area.

In some embodiments, designating may include designating the display area as an always on top area relative to other images to be displayed on the screen.

In some embodiments, a method may include selecting a duration of -time during which a unit of message data is to appear in the display area, where the selecting is done for example by an operator of the server.

In some embodiments, an operator may select a frequency at which the message data is to appear in the display area.

In some embodiments, a method may include accepting message data from a server, where the message data corresponds to categories of message data pre-selected by an operator of the server.

In some embodiments, a method may include accepting a signal from a user of the screen to send additional message data related to the accepted message data, sending the additional message data to the user in a communication mode such as email and small message system.

In some embodiments, a method includes displaying the message data in the display area until the user responds to the message, where the response is pre-defined as associated with the message.

### BRIEF DESCRIPTION OF THE DRAWINGS

The subject matter regarded as the invention is particularly pointed out and distinctly claimed in the concluding portion of the specification. The invention, however, both as to organization and method of operation, together with features and advantages thereof, may best be understood by reference to the following detailed description when read with the accompanied drawings in which:

FIG. 1 is a schematic diagram of a system in accordance with an embodiment of the invention;

FIG. 2 is a diagram of a screen of a display having a scroll area in accordance with an embodiment of the invention; and

FIG. 3 is a flow diagram of a method in accordance with an embodiment of the invention.

### DETAILED DESCRIPTION OF EMBODIMENTS OF THE INVENTION

In the following description, various embodiments of the invention will be described. For purposes of explanation, specific examples are set forth in order to provide a thorough understanding of at least one embodiment of the invention. However, it will also be apparent to one skilled in the art that other embodiments of the invention are not limited to the examples described herein. Furthermore, well-known features may be omitted or simplified in order not to obscure embodiments of the invention described herein.

Unless specifically stated otherwise, as apparent from the following discussions, it is appreciated that throughout the specification, discussions utilizing terms such as “selecting,” “evaluating,” “processing,” “computing,” “calculating,” “associating,” “determining,” “designating,” “allocating” or the like, refer to the actions and/or processes of a computer, computer processor or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

The processes and functions presented herein are not inherently related to any particular computer, network or other apparatus. Embodiments of the invention described herein are not described with reference to any particular programming language, machine code, etc. It will be appreciated that a variety of programming languages, network systems, protocols or hardware configurations may be used to implement the teachings of the embodiments of the invention as described herein. In some embodiments, one or more methods of embodiments of the invention may be stored on an article such as an article of memory, where such instructions upon execution result in a method of an embodiment of the invention.

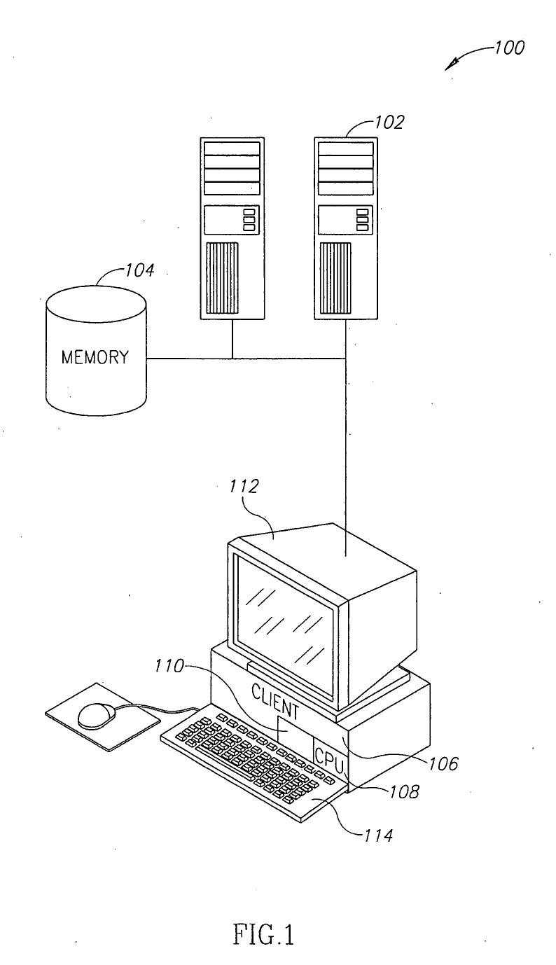

Reference is made to FIG. 1, a schematic diagram of a system in accordance with an embodiment of the invention. In some embodiments a system 100 may comprise one or more servers 102 or processors and memory storage units 104 that may be linked or connected by way of for example a network such as a local area network or wide area network. One or more of servers 102 may be connected to one or more clients 106 by way of for example a network connection. Client 106 may include one or more of a processor 108, a memory 110, a screen 112 or display and an input device such as a keyboard, mouse or other input device 114. In some embodiments, a client 106 may be connected to a single server 102, and such single server 102 may be connected to one or more other servers 102, to provide client 106 with access to information stored on or delivered from one or more of such other servers 102.

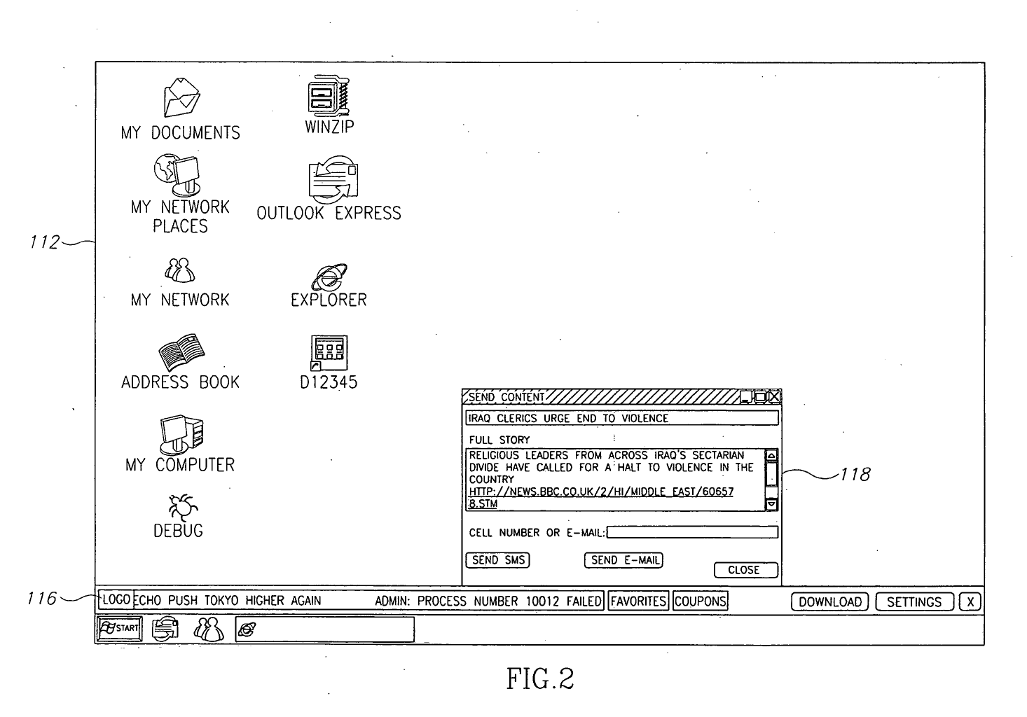

Reference is made to FIG. 2, a schematic diagram of a display and an area of the display designated for message data, in accordance with an embodiment of the invention. In some embodiments, processor 108 may run a software application or set of instructions that may designate one or more areas 116 on screen 112 as a display area for messages or message data that may be delivered to client 106 from for example server 102. In some embodiments, area 116 may be a rectangular area above or near a bottom program bar, as such program bars are typically displayed when running for example an MS Windows™-based application. Area 116 may be of sufficient size to display text or small icon graphics. Other sizes, shapes, locations and formats for area 116 are possible.

In some embodiments, a user or operator of client 106 or server 102 may select categories of message data that are to be requested or accepted by client 106 from server 102 for display on area 116 of screen 112. At various intervals, message data may be delivered from for example server 102 to client 106, and may be displayed in area 116 of screen 112 by scrolling such message data across area 116. Other presentations besides scrolling such as flashing, fading or the like are also possible. In some embodiments, new message data may be highlighted as it passes for a first time through area 116.

In some embodiments, area 116 maybe be assigned an ‘always on top’ status, so that area 116 and the message data that it displays appears on screen 112 regardless of the application that may be displayed on screen 112 at any particular time. In some embodiment a ‘mouse over’ the area 116 may be disabled so that the area 116 is not changed by actions of a mouse, other than to click on message data about which a user may want additional messages or other functions. In some embodiments, a user may be able to hide or unhide area 116 through an action of a mouse or other input output device.

In some embodiments, a user may click on a message data, to activate a pop-up box 118 that may provide additional data that may be related to the message data. For example, a pop-up box 118 may include an elaboration of a message data that may have scrolled through area 11.6.

In some embodiments, a user or operator of client 106 or of server 102 may pre-select or pre-define categories of message data or advertisements that are to be transmitted to or accepted by a particular client 106, such that message data to be received by a particular client may be personalized to match the needs or desires of the client 106. Such personalization may be managed by one or more of the operators of the client 106 or an operator of the server 102, and may be stored in for example server 102 or in a data base to which server 102 is accessible. A duration, rate or frequency of displays of message data, direction of scrolling, and number of scrolling bars may also be personalized by one or more of a user of screen 112 or an operator of server 102, so that scrolled messages are displayed for example quickly and then disappear, or so that messages are only displayed at a particular time period or at a given periodicity, or that a flow of message data or of a particular message may stop in an area 116 to allow a user to read or notice the message.

In some embodiments, a record may be kept of a user's clicks on area 116 or actions such as forwarding of message data to others or to other communication media, and a data base of a user's likes and interests may be mined or collected. In some embodiments, a profile of a user may be stored on server 102, and data mining of such user's interaction with the system may be performed from such server 102. Further message data, promotional campaigns or offers may be delivered to the user based on his prior choices or clicks. In some embodiments a profile of the user may be updated manually or automatically, based on his past interactions with the system 100. In some embodiments, data messages may be selected for delivery to a user based on a location or other characteristic of a user, such as for example purchasing habits or hobbies. In some embodiments, a user may be included in a work group or other classification, and message data may be classified by content or other criteria and distributed to users in one or more profile groups or work groups on the basis of the criteria. In some embodiments, a user can be requested to click on or otherwise respond to a particular unit of message data to confirm his receipt or acknowledgement of the message, and such acknowledgement may be recorded by a server, operator or sender of a message. A pre-defined response by a user may be associated with a particular message so that for example a user must type in ‘yes’ or ‘no’ to certain messages.

In some embodiments, a user of screen 112 may click on the scrolling message or a part of the message to see some or all of the message data or to see or retrieve further data that may be related to the message. In some embodiments a system may accept an instruction from a user to send additional or other data related to a message by way of another communication medium such as for example email or small message system.

In some embodiments, a size or useable area of the screen that is available to a particular application that may be running and shown on a screen, may be decreased to accommodate the area 116 occupied by the message scroll bar. In some embodiments the client 106 may include default setting such as speed, font type and size, background color, communication settings such as port/ip that may be maintained by the end user or used as a default for communication with server 102 and for display on screen 1 12.

In some embodiments, an operator or content provider of a system may determine a timing or periodicity of when a particular unit of message data is to be posted or transmitted, and the characteristics of such message data (font,. color, etc.). In some embodiments, a user may also determine when to receive a particular class or kind of message data. For example, a user may select to receive work related message data during the day and leisure related message data in the evening. In some embodiments, an operator may indicate that a unit of message data is of particular importance by highlighting or otherwise visually emphasizing a message. In some embodiments, a user may define one or more classes of messages that are to be highlighted or responded to when they reach his client 106, and may pre-define a type of response that is to be received by a user or client 106.

In some embodiments, message data may be pulled by an agent of client 106 from server 102 on a regular or periodic basis to determine if new content has been added to the server 102 in a pre-defined category to be displayed on screen 112. Server 102 may gather content and information whether manually upon operator input or automatically from different sources (such as web sources, portals, other information systems, ERPs, CRM, monitoring systems, etc.) and categorize it based on a predefined logic. In some embodiments, server may communicate with client over an HTTP, HTTPs protocol and/or may use XML protocols for formatting message data. In some embodiments, a user's information may be stored in a client registry and a server may communicate with a client from one or more of multiple server sources once the client 106 has logged onto the system 100. Client 106 may then be able to log in to the system regardless of physical location, and his preferences of the system may be updated from the client registry.

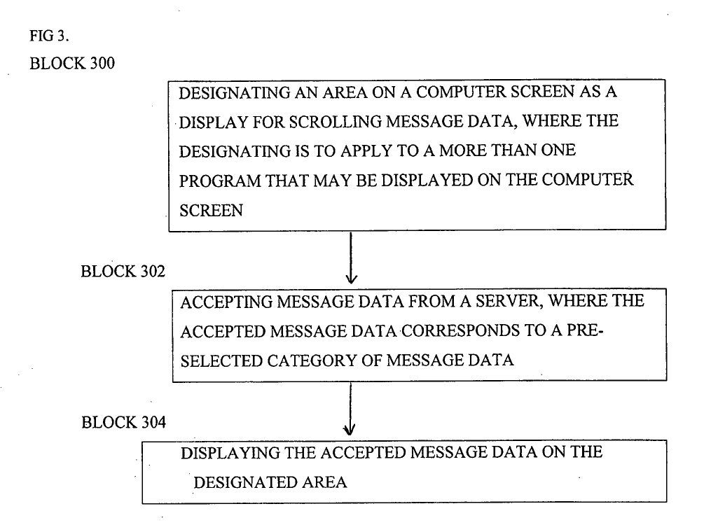

Reference is made to FIG. 3, a flow diagram of a method in accordance with an embodiment of the invention. In block 300, a method may designate an area on a display screen as an area for scrolling message data, where the area appears on a display of more than one of the applications that are to appear on the display screen.

In block 302, a client may accept message data from a server where the message data corresponds to categories of message data that were pre-selected by a user of the display screen;

In block 304, the accepted messages may be displayed in the designated area.

In some embodiments, the message data may scroll or roll across the designated area. In some embodiments an operator of a screen or of a server that transmits message data may control or adjust a speed or frequency of display of message data in a designated area. In some embodiments, a message data may be transmitted with an indication of a severity, importance or priority, based on for example a rule that may have been pre-defined by a user of a screen or client or by an operator of a server.

In some embodiments, a user may click or otherwise signal on a message data display or elsewhere to receive additional information relating to a unit of message data, or to suspend a movement of message data across a designated area.

In some embodiments, a designated area may be in an ‘always on top’ mode relative to some or all other applications that may be displayed on a screen.

In some embodiments, a user or other operator may designate a frequency at which message data is to scroll or appear in a designated area of a screen.

In some embodiments, an operator of a server may pre-select one or more categories of message data that are to be transmitted to a screen and that are to appear on a designated area. In some embodiments, an operator may override a client's election to limit receipt of message data.

In some embodiments, a server may accept a signal from a user to save message data or transmit to the user additional data relating to the message, where the additional data is transmitted over a separate communications media such as for example email, SMS or small message system. In some embodiments, a server may save or track data on a unit of message data that a user saves, forwards or responds to. In some embodiments, a server may retain a reference number that corresponds to a message that may have been saved by a user, even though such message may have been deleted from the server. In some embodiments, a server may be programmed to distribute queries or surveys to one or more users, and may collect responses to such queries, and show distributed messages with such collected responses to one or more users.

In some embodiments, a system may accept a signal to suspend or stop a scrolling of a unit of message data across the scroll bar to allow for example a user to read or focus on the message.

In some embodiments a user of a screen or client or an operator of a may define one or more queries that may be run by a user or that may be displayed to a user at pre-defined times regarding the message data that may have been shown to other users on the system or about the messages or replies to such messages that may have been provided from other users.

It will be appreciated by persons skilled in the art that embodiments of the invention are not limited by what has been particularly shown and described hereinabove. Rather the scope of at least one embodiment of the invention is defined by the claims below.

We claim:

1. A method comprising:
designating an area on a computer screen as a display area for message data, said display area to appear when a display of any of a plurality of programs is displayed on said computer screen;
accepting message data from a server, said accepted message data corresponding to categories of pre-selected message data; and
displaying said accepted message data on said display area.

2. The method as in claim 1, wherein said displaying said message data on said display area comprises scrolling said message date on said display area.

3. The method as in claim 1, wherein said accepting comprises accepting a unit of message data at a frequency that is pre-selected by an operator of said server.

4. The method as in claim 1, comprising accepting a signal from an operator of said screen to request additional data about said message data.

5. The method as in claim 1, comprising accepting a signal from a user of said screen to suspend a unit of message data in said designated display area.

6. The method as in claim 1, wherein said designating comprises designating said area as an always on top area relative to other images to be displayed on said screen.

7. The method as in claim 1, comprising selecting a duration of time during which said message data is to appear in said display area, said selecting by an operator of said server.

8. The method as in claim 1, selecting a frequency at which said message data is to appear in said display area, said selecting by an operator of said server.

9. The method as in claim 1, wherein said accepted message data corresponds to categories of message data pre-selected by an operator of said server.

10. The method as in claim 1, wherein said accepted message data corresponds to categories of message data pre-selected by an operator of said computer screen.

11. The method as in claim 1, comprising
accepting a signal from a user of said screen to send additional message data related to said accepted message data,
sending said additional message data to said user in a communication mode selected from the group consisting of email and small message system.

12. The method as in claim 1, comprising displaying said message data in said area until a user of said screen responds to said message, said response associated with said message.

13. An article having stored thereon instructions that when executed by a processor result in:
designating an area on a computer display screen to display scrolling message data, said designating to apply to a plurality of applications that may appear on said display, said area to appear on said display during an operation of said applications; and
accepting message data from a server, said message data corresponding to categories of message data pre-selected by an operator of said screen;
displaying said accepted message data on said designated area

14. The article as in claim 13, said instructions to accept a unit of message data at a frequency that is selected by said user of said screen.

15. The article as in claim 13, said instructions to accept a signal from said operator of said screen to request additional data about said message data.

16. The article as in claim 13, said instructions to accept a signal from said user of said screen to suspend a unit of message data in said designated area.

17. The article as in claim 13, said instructions to accept a signal from an operator of said server designating a duration of time during which said message data is to appear in said area.

18. A system comprising a processor and a memory:
said memory to store a pre-defined category of message data to be delivered to a client;
said processor to:
designate an area on a display of said client, said area to appear on a plurality of applications that are displayed on said display;
accept message data corresponding to said pre-defined category; and
scroll said message data across said area.

19. The system as in claim 18, wherein said processor is to accept a unit of said message data at a frequency that is selected by said user of said client.

20. The system as in claim 18, wherein said processor is to accept a signal from an operator of said client to request additional data about said message data.

21. The system as in claim 18, wherein said processor is to accept a signal from said client to suspend a unit of message data in said designated area.
